(19) United States
(12) Patent Application Publication
(10) Pub. No.: US 2014/0121299 A1
(43) Pub. Date: May 1, 2014

(54) ADDUCTS AS TOUGHENERS IN THERMOSETTABLE EPOXY SYSTEMS

(71) Applicants: Yan L. Feng, Shanghai (CN); Joseph Gan, Strasbourg (FR); Wayne Y. Zhang, Shanghai (CN); Patrick P. Yan, Shanghai (CN)

(72) Inventors: Yan L. Feng, Shanghai (CN); Joseph Gan, Strasbourg (FR); Wayne Y. Zhang, Shanghai (CN); Patrick P. Yan, Shanghai (CN)

(73) Assignee: DOW GLOBAL TECHNOLOGIES LLC, Midland, MI (US)

(21) Appl. No.: 14/125,977

(22) PCT Filed: Jul. 4, 2011
(86) PCT No.: PCT/CN11/76822

§ 371 Date: Dec. 13, 2013

(51) Int. Cl. C08G 59/22; C08L 63/00

(52) U.S. Cl. CPC C08G 59/22; C08L 63/00
USPC 523/427; 548/232

(57) ABSTRACT

A liquid adduct consisting essentially of a reaction product of (a) an aliphatic epoxy resin, and (b) an isocyanate compound, wherein the viscosity of the adduct comprises less than about 60 Pa-s at about 25° C. is disclosed. The adduct can be used in an epoxy resin composition.

### BACKGROUND OF THE INVENTION

1. Field of the Invention

The present invention relates to adducts as tougheners used in thermosettable epoxy systems and a composition including the toughener; and more specifically, the present invention relates to an oxazolidone ring containing adduct wherein said adduct is used as a toughener and a composition made from said adduct.

2. Description of Background and Related Art

Epoxy resin compositions have been widely used in various applications for their good temperature resistance and mechanical properties. When fully cured, a clear cast sample from typical epoxy resin compositions can have a glass transition temperature (Tg) of more than 130° C. and both tensile modulus and flexural modulus higher than 3 GPa. However, the toughness of cured epoxy compositions is usually low and this weakness has greatly restricted the use of epoxy compositions in certain applications. For example, the impact resistance of cured liquid epoxy resins (LER) with methyl tetrahydrophthalic anhydride (MTHPA) is about 8 kJ/m² and in many applications such as electrical casting or composites. An ideal impact resistance should be higher than 10 kJ/m².

It is well known in the industry to use soft backbone polymers as flexibilizers to improve the impact resistance. For example, in cured systems for electrical casting containing anhydrides, polyether glycol is widely used. Unfortunately such a flexiblizer will significantly reduce the Tg, for example 5% weight addition of polyether glycol to epoxy will reduce Tg as much as 20° C. and modulus by 10% in certain cases. An alternative way is to use epoxide functionalized polyether glycol. The higher functionality will help maintain the Tg as greater than 120° C. However while Tg is required to be greater than 130° C., the impact resistance is not improved even with the addition of epoxidized polyether glycol.

Other than flexibilizers, phase-separated materials called tougheners have been incorporated into epoxy compositions to improve the impact resistance, particularly for fiber-reinforced composites. These type of tougheners are dispersed into matrices as incompatible (phase separated) particles and the particles will stop the craze growth before it develops into major crack. Carboxyl-terminated butadiene-acrylonitrile rubber (CTBN) or core-shell rubbers (CSR) are two major types of tougheners in composites application. Usually CTBN and CSR are better than flexibilizers to maintain high Tg but both of them reduce modulus. At 5% dosage level, CTBN and CSR can reduce the modulus by 15-20%. Another drawback of CTBN and CSR is the very high viscosity of both compounds and incompatibility to epoxy compositions which makes the processing very difficult, so the quality consistence is hard to control. This can be seen from the broad deviation of test results from specimens containing phase-separated materials. Also the opaque appearance from phase separation makes the visual check on composites very difficult.

It is also known to use amphiphilic block copolymers, such as FORTEGRA™ 100 series, as tougheners for epoxy compositions. Such amphiphilic block copolymers can be made at low viscosity to facilitate the processing and phase separate during the curing process. However, the modulus from such amphiphilic block copolymers is still not satisfactory.

Accordingly, what is needed in the industry are different and better tougheners for epoxy compositions such that while improving tougheness, both Tg and modulus can be maintained without reduction.

### SUMMARY OF THE INVENTION

One aspect of the present invention is directed to an adduct comprising, consisting of or consisting essentially of a reaction product of
(a) a polyether glycol epoxy resin, and
(b) an isocyanate compound.

Another aspect of the present invention is directed to a composition comprising, consisting of, or consisting essentially of
(a) an adduct as described above;
(b) at least one epoxy resin; and
(c) at least one hardener.

### BRIEF DESCRIPTION OF THE FIGURE

FIG. 1 is the mass spectrum of Example XQR-19 compared with the mass spectra of DER™ 736 and PAPI 27.

### DETAILED DESCRIPTION OF THE INVENTION

In the present invention, an oxazolidone ring containing adduct obtained using an aliphatic epoxy compound and isocyanate was trialed as a toughener for epoxy compositions. From the results, it could be seen that the inventive example could improve the impact resistance while still maintain the Tg and modulus without a loss.

In the following detailed description, the specific embodiments of the present invention are described in connection with its preferred embodiments. However, to the extent that the following description is specific to a particular embodiment or a particular use of the present techniques, it is intended to be illustrative only and merely provides a concise description of the exemplary embodiments. Accordingly, the present invention is not limited to the specific embodiments described below, but rather; the invention includes all alternatives, modifications, and equivalents falling within the true scope of the appended claims.

Unless otherwise stated, a reference to a compound or a component includes the compound or component by itself, as well as in combination with other compounds or components, such as mixtures or combinations of compounds.

As used herein, the singular forms “a,” “an,” and “the” include the plural reference unless the context clearly dictates otherwise.

### The Composition

In an embodiment, the present invention includes a composition comprising, consisting of, or consisting essentially of a mixture of
(a) one or more epoxy resins of oxazolidone ring containing adducts;
(b) one or more epoxy resins; and
(c) one or more hardeners.

### Oxazolidone Ring Containing Adduct

In preparing the thermosetting resin of the present invention, the composition may include at least one or more special epoxy resins of oxazolidone ring containing adduct as component (a).

For example, the adduct may include the reaction products of poly propyleneglycol diglycidyl ether, dipropyleneglycol diglycidyl ether, 1,6-hexanediol diglycidyl ether, 1,4-Butanediol diglycidyl ether and other aliphatic epoxies, polyisocyanates, and mixtures thereof.

In one embodiment, the oxazolidone ring containing adduct
(a) may comprise a reaction product of
   (i) at least one epoxy compound and
   (ii) at least one isocyanate compound.

For example, the epoxy compound (I) may comprise an aliphatic epoxy. The isocyanate compound (II) may comprise for example, a polymeric isocyanate. The isocyanates may be used as a mixture of two or more of isocyanates.

The isocyanates may also be any mixture of the isomers of an isocyanate, for example a mixture of the 2,4- and 2,6-isomers of MDI or a mixture of any 2,2′-, 2,4′- and 4,4′-isomers of TDI.

Examples of commercially available diisocyanate that are suitable for the present invention include, for example, ISONATE™ M124, ISONATE™ M125, ISONATE™, OP 50, PAPI 27, VORONATE™ M229, and VORANATE™ T-80, available from The Dow Chemical Company.

A catalyst or a mixture of catalysts may be used to make oxazoldione containing adducts. More preferred catalysts suitable for the present invention include aminecontaining compounds such as 1,8-Diazabicyclo[5.4.0]undec-7-ene (DBU), imidazole derivatives including 2-methyl imidazole, 2-phenyl imidazole (2-PhI); phosphonium and 30 ammonium salts; and any mixture thereof. Most preferred catalysts used in the present invention are 2-PhI and DBU. It has been discovered that both catalysts yield high percentages of oxazolidone rings (e.g. greater than about 95% of oxazolidone conversion), and low percentages of isocyanurate rings (e.g. less than 5% of isocyanurate conversion) under the reaction temperatures being considered (i.e. about 150° C. to about 200° C.).

The amount of catalysts used for the present invention may be from about 10 to about 50000 ppm, preferably between about 50 to about 10000 ppm, more preferably between about 100 to about 5000 ppm, and most preferably between 5 about 200 to about 2000 ppm based on the total weight of the epoxy resin composition.

In another embodiment, the oxazolidone ring containing adduct (a) may comprise a compound of Formula I:

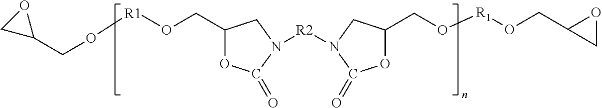

### Formula I

R1: aliphatic chain or polyol chain

R2: phenyl or polymeric phenyl ring structure

n: is an integer of at least 1. In an embodiment, n is an integer between 1 and 4.

The concentration of the special epoxy of oxazolidone ring containing adduct (a) may be from between about 0.1 percent by weight (wt %) to about 40 wt %, preferably between about 0.2 wt % to about 30 wt %, more preferably between about 1 wt % to about 20 wt % based on the weight of the total organic compound.

### Epoxy Resin(s)

In preparing the thermosetting resin of the present invention, the composition may include at least one or more epoxy resins as component (b). Epoxy resins are those compounds containing at least one vicinal epoxy group. The epoxy resin may be saturated or unsaturated, aliphatic, cycloaliphatic, or heterocyclic and may be substituted. The epoxy resin may also be monomeric or polymeric. The epoxy resin useful in the present invention may be selected from any known epoxy resins in the art.

The epoxy resins, used in embodiments disclosed herein for component (b) of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

The epoxy resin useful in the present invention for the preparation of the epoxy resin composition may be selected from commercially available products. For example, D.E.R.™ 331, D.E.R.™ 332, D.E.R.™ 334, D.E.R.™ 580, D.E.N.™ 431, D.E.N.™ 438, D.E.R.™ 736, or D.E.R.™ 732 or XZ 92447.00 or XZ 97104.00, or XZ92486.00, or XZ 92766.00 available from The Dow Chemical Company may be used. As an illustration of the present invention, the epoxy resin component (a) may be a liquid epoxy resin, D.E.R.™ 383 (diglycidyl ether of bisphenol A) having an epoxide equivalent weight of 175-185, a viscosity of 9.5 Pa-s and a density of 1.16 g/cc. Other commercial epoxy resins that can be used for the epoxy resin component can be D.E.R.™ 330, D.E.R.™ 354, or D.E.R™ 332.

Other suitable epoxy resins useful as component (b) are disclosed in, for example, U.S. Pat. Nos. 3,018,262. 7,163,973, 6,887,574, 6,632,893, 6,242,083, 7,037,958, 6,572,971, 6,153,719, and 5,405,688, PCT Publication WO 2006/052727; U.S. Patent Application Publication Nos. 20060293172, 20050171237, 2007/0221890 A1; each of which is hereby incorporated herein by reference.

In one preferred embodiment, the epoxy resin useful in the composition of the present invention comprises any aromatic or aliphatic glycidyl ether or glycidyl amine or a cycloaliphatic epoxy resin.

For example, in one embodiment, the epoxy resin (b) includes, but is not limited to aliphatic epoxy resins, cycloaliphatic epoxy resins, bisphenol A epoxy resins, bisphenol F epoxy resins, phenol novolac epoxy resins, cresol-novolac epoxy resins, biphenyl epoxy resins, polyfunctional epoxy resins, naphthalene epoxy resins, divinylbenzene dioxide, 2-glycidylphenylglycidyl ether, dicyclopentadiene-type epoxy resins, phosphorous containing epoxy resin, multi aromatic resin type epoxy resins, and mixture therefore.

The composition of the present invention may include other resins such as diglycidyl ether of bisphenol A, diglycidyl ether of bisphenol F, cycloaliphatic epoxies, multifunctional epoxies, or resins with reactive and non-reactive diluents.

In general, the choice of the epoxy resin used in the present invention depends on the application. However, diglycidyl ether of bisphenol A (DGEBA) and derivatives thereof are particularly preferred. Other epoxy resins can be selected from but limited to the groups of: bisphenol F epoxy resins, novolac epoxy resins, glycidylamine-based epoxy resins, alicyclic epoxy resins, linear aliphatic and cycloaliphatic epoxy resins, tetrabromobisphenol A epoxy resins, and combinations thereof.

The concentration of the epoxy resin (b) may be from between about 0 weight percent to about 99 weight percent, preferably between about 20 percent to about 80 weight percent, more preferably between about 30 weight percent to about 60 weight percent based on the total weight of the composition.

### Hardener(s)

In the broadest terms of the present invention, a hardener (curing agent or cross-linker) or curing agent blend is used in the present invention as component (c). Generally, any hardener known in the art which is appropriate for curing epoxy resins may be used. The hardener of choice may depend on the application requirements. The hardener useful in the present invention may include, for example, but are not limited to, dicyandiamide, substituted guanidines, phenolic, amino, benzoxazine, anhydrides, amido amines, polyamides, polyamines, aromatic amines, polyesters, polyisocyanates, polymercaptans, urea formaldehyde and melamine formaldehyde resins, and mixtures thereof.

For example, in one embodiment, the hardener (c) includes anhydride hardener or amine hardener. Anhydride hardeners include, but are not limited to, phthalic acid anhydride and derivatives, nadic acid anhydride and derivatives, trimellitic acid anhydride and derivatives, pyromellitic acid anhydride and derivatives, benzophenonetetracarboxylic acid anhydride and derivatives, dodecenylsuccinic acid anhydride and derivatives, poly(ethyloctadecanedioic acid) anhydride and derivatives, and the like, and these can be used alone or in an admixture thereof. Hexahydrophthalic anhydride, methyl hexahydrophthalic anhydride, tetrahydrophthalic anhydride, methyl tetrahydrophthalic anhydride, nadic acid anhydride, and methyl nadic acid anhydride are particularly suitable for this invention. Amine hardeners include, but are not limited to, dicydiamide (DICY), ethylenediamine (EDA), diethylenetriamine (DETA), triethylenetetramine (TETA), trimethyl hexane diamine (TMDA), hexamethylenediamine (HMDA), N-(2-aminoethyl)-1,3-propanediamine (N-3-Amine), N,N′-1,2-ethanediylbis-1,3-propanediamine (N-4-amine), dipropylenetriamine, m-xylylenediamine (mXDA), isophorone diamine (IPDA), diaminodiphenylmethane (DDM), diaminodiphenylsulfone (DDS), 2-Ethyl-6-methylaniline (MEA).

The concentration of the hardener (c) may be from between about 0 weight percent to about 99 weight percent, preferably between about 3 weight percent to about 60 weight percent, more preferably between about 10 weight percent to about 50 weight percent based on the total weight of the composition.

A molar ratio of the epoxy components [components (a) and (b)] to the hardener (c) in the composition may be a molar ratio chosen between about 50:1 to about 1:2 in one embodiment; between about 30:1 to about 1:2 in another embodiment; between about 20:1 to about 1:1.5 in yet another embodiment; and between about 10:1 to about 1:1.25 in still another embodiment.

### Optional Component—Accelerator(s)/Catalysts

If desired, the composition of the present invention can contain one or more accelerators or catalysts, for the reaction between the epoxy resin and the amine substituted aromatic sulfonic acid amide. Suitable accelerators or catalysts include, for example, 2-methyl imidazole, 2-ethyl-4-methylimidazole, 2-isopropylimidazole, 1-propylimidazole, 2-heptadecylimidazole, benzyldimethylamine, ethyltriphenylphosphonium acetate, ethyltriphenylphosphonium chloride, ethyltriphenylphosphonium bromide, ethyltriphenylphosphonium iodide, ethyltriphenylphosphonium diacetate (ethyltriphenylphosphonium acetate.acetic acid complex), ethyltriphenylphosphonium tetrahaloborate, tetrabutylphosphonium chloride, tetrabutylphosphonium acetate, tetrabutylphosphonium diacetate (tetrabutylphosphonium acetate.acetic acid complex), tetrabutylphosphonium tetrahaloborate, butyltriphenylphosphonium tetrabromobisphenate, butyltriphenylphosphonium bisphenate, butyltriphenylphosphonium bicarbonate, benzyltrimethylammonium chloride, benzyltrimethylammonium hydroxide, benzyltrimethylammonium tetrahaloborate, tetramethylammonium hydroxide, tetrabutylammonium hydroxide, tetrabutylammonium tetrahaloborate, triethylamine, tripropylamine, tributylamine, 2-methylimidazole, benzyldimethylamine, triethylammonium chloride, triethylammonium bromide, triethylammonium iodide, triethylammonium tetrahaloborate, tributylammonium chloride, tributylammonium bromide, tributylammonium iodide, tributylammonium tetrahaloborate, N,N′-dimethyl-1,2-diaminoethane.tetrahaloboric acid complex, mixtures thereof, and the like.

The concentration of the optional accelerator or catalyst may be from between about 0 wt % to about 10 wt %, preferably between about 0 wt % to about 8 wt %, more preferably between about 0 wt % to about 2 wt % based on the weight of the composition.

### Optional Component—Filler(s)

Filler can be used as an optional component in the composition. When the composition contains inorganic filler, the inorganic filler can be selected among any inorganic filler, preferably among silica, talc, quartz, mica, and flame retardant fillers such as aluminum trihydroxide, magnesium hydroxide, or boehmite.

The concentration of inorganic filler is preferably chosen between about 0% to about 95%, based on the total weight of the composition, preferably between about 0% to about 90%, more preferably between about 0% to about 80%. Preferably, at least one average dimension of the inorganic filler particles is below about 1 mm, preferably below about 100 micron, more preferably below about 50 micron, and even more preferably below about 10 micron, and above about 2 nm, preferably above about 10 nm, more preferably above about 20 nm, and even more preferably above about 50 nm.

The concentration of the optional filler may be from between about 0 wt % to about 95 wt %, preferably between about 0 wt % to about 90 wt %, more preferably between about 0 wt % to about 80 wt % based on the weight of the composition.

### Optional Component—Solvent(s)

Solvents can be used as optional in the composition. Solvents (f) include, but are not limited to, methyl ethyl ketone (MEK), dimethylformamide (DMF), ethyl alcohol (EtOH), propylene glycol methyl ether (PM), propylene glycol methyl ether acetate (PMA) and mixtures thereof.

The concentration of the optional solvent may be from between about 0 wt % to about 80 wt %, preferably between about 0 weight percent to about 60 weight percent, more preferably between about 0 weight percent to about 50 weight percent based on the total weight of the composition.

### Optional Component—Reinforcing Fiber(s)

Reinforcing fiber also could be used as optional composition in the invention formulation. Reinforcing fiber could be, but not limited to, glass fiber, carbon fiber and cellulose fiber.

The concentration of the optional reinforcing fiber may be from between about 0 weight percent to about 95 weight percent, preferably between about 0 weight percent to about 90 weight percent, more preferably between about 0 weight percent to about 80 weight percent based on the total weight of the composition.

### Other Optional Components

The thermosetting composition may further include a second thermosetting resin different from the epoxy resin (b) and different from the hardener (c). The thermosetting composition may further include at least one solvent. The thermosetting composition according to the invention may further include one or more additives chosen from additional flame retardants, additional toughening agents different from the oxazolidone ring containing adduct (a), curing inhibitors, wetting agents, colorants, thermoplastics, processing aids, dyes, UV-blocking compounds, and fluorescent compounds. This list is intended to be exemplary and not limiting.

The concentration of any of the other optional components which may be added to the composition of the present invention may be from between about 0 weight percent to about 20 weight percent, preferably between about 1 weight percent to about 15 weight percent, more preferably between about 2 weight percent to about 10 weight percent based on the weight of the composition.

### The Curing Process

The composition of the present invention may be cured under the following conditions: 50-100° C. for 0.5 to 3 hours, 100-150° C. for 0.5 to 3 hours and 160-200° C. for 0.5 to 3 hours in a mold. Longer curing time and/or higher curing temperature might be needed for cured products having higher cured Tg. The curing temperature and time depend on the levels of hardeners and the catalysts needed for different applications. The curing conditions are not limited to the current description.

### The Product

### Cured Product and Properties

The thermoset product (i.e. the cross-linked product made from the curable composition) of the present invention shows several improved properties over conventional epoxy cured resins. For example, the cured product of the present invention may have a glass transition temperature (Tg) of from about 80° C. to about 250° C. in one embodiment; from about 100° C. to about 200° C. in another embodiment; from about 120° C. to about 170° C. in yet another embodiment; and from about 130° C. to about 150° C. in still another embodiment.

The thermoset product of the present invention exhibits a flexural modulus of higher than about 3,200 MPa, preferably from about 2,900 MPa to about 4,000 MPa and more preferably from about 3,000 MPa to about 3,500 MPa.

The thermoset product of the present invention exhibits a flexural strength value of higher than about 130 MPa, preferably from about 110 MPa to about 150 MPa, and more preferably from about 120 MPa to about 140 MPa.

The thermoset product of the present invention exhibits a tensile modulus value of higher than about 2,900 MPa, preferably from about 2,700 MPa to about 4,000 MPa, and more preferably from about 2,800 MPa to about 3,500 MPa.

The thermoset product of the present invention exhibits a tensile strength value of higher than about 85 MPa, preferably from about 75 MPa to about 100 MPa, and more preferably from about 80 MPa to about 90 MPa.

### End Uses

The curable composition of the present invention may be used in thermoset systems where conventional curable epoxy resins are used. Some non-limiting examples of applications wherein the formulation of present invention may be used include, for example, fiber reinforced composites made from various application methods including filament winding, pultrusion, resin transfer molding, vacuum assisted infusion and prepreg process. Another area is in electrical insulation and encapsulation by application methods including casting, potting and automatic pressurized gelation (APG) etc. The composition can also be used as potting material for road pavement and civil engineering. By adequate application methods like spray, roller, dip etc. the composition can also be used as coating for a great variety of end uses including ship, marine containers, machinery, structural steel frames, and automotive.

### EXAMPLES

The following examples and comparative examples further illustrate the present invention in detail but are not to be construed to limit the scope thereof.

Various terms and designations used in the following examples are explained herein below:

D.E.R.™ 383 resin is a bisphenol-A diglycidyl ether having an EEW of 181 and commercially available from The Dow Chemical Company.

“Example XQR-19” is an oxazolidone ring containing adduct which is synthesized by The Dow Chemical Company.

Fortegra®-100 is a block copolymer commercially available from The Dow Chemical Company.

“MTHPA” stands for methyltetrahydrophthalic anhydride and is commercially available from Alpharm Fine Chemical Company.

Ethyltriphenylphosphonium acetate solution (70% solid content in methanol) is commercially available from Deepwater Chemical Company.

The following standard analytical equipments and methods are used in the Examples:

### Epoxide Equivalent Weight

The epoxide equivalent weight (EEW) was determined by using ASTM method D1652. EEW is determined by reacting the epoxides with in-situ produced hydrobromic acid. Hydrobromic acid is generated by the addition of perchloric acid to excess of tetraethyl ammonium bromide. The method is a potentiometric titration, where the potential of the titrated sample is slowly increasing upon the addition of the perchloric acid until hydrobromic acid is consumed by the epoxide. After the completion of the reaction a sudden potential increase occurs and that is indicative of the amount of epoxide present.

### Glass Transition Temperature

Glass transition temperature (Tg) was measured by differential scanning calorimetry (DSC). Approximately 5-10 mg of sample was analyzed in an open aluminum pan on a TA Instrument DSC Q2000 fitted with an auto sampler under N2. Tg measurement by DSC was with 30-220° C., 10° C./min; 30-250° C., 10° C./min; 2 circles.

### Mechanical Properties

The mechanical properties were tested with as instrument: Instron 5566 and Resil Impactor (Ceast 6960). The following test methods were used:
Tensile test: ISO 527 Test speed: 5 mm/min; Gaugelength: 50 mm.
Flexure test: ISO 178 Test speed: 2 mm/min; Support span: 64 mm.
Impact test: ISO 179 Support span: 62 mm; Pendulum energy: 2 J.

The mechanical properties measurements are done by 10 pieces of panel for each measurement item with two different times for each formulation. The results are analysed in a statistical way by JMP software including the variance effect of each time measurement and testing panel preparation. Therefore at the end the ranking results from statistical software include the mean value comparation and variance comparation based on the overall testing results. Among the ranking results, different ranking character/level indicates a significant different level of the results, while the same ranking character indicates the same level of the results even though the number of the results might be still different by itself, but considering the variance of the measurement system then the comparation results are still the same level based on the same ranking character. In term of the ranking sequence: A is better than B which is better than C and C is better than D.

### Example 1

An oxazolidone ring containing adduct obtainable by an aliphatic epoxy compound and an isocyanate (the general chemical structure of adduct as shown in Formula I) was used as a toughener in a formulation for composite application.

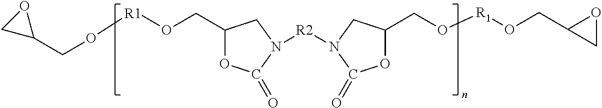

### Formula I

The oxazolidone ring containing adduct which was used in the present Examples is Example XQR-19 which was synthesized on a laboratory scale. The EEW of Example XQR-19 is 313. The reaction scheme used to prepare Example XQR-19 is shown in Scheme I as follows:

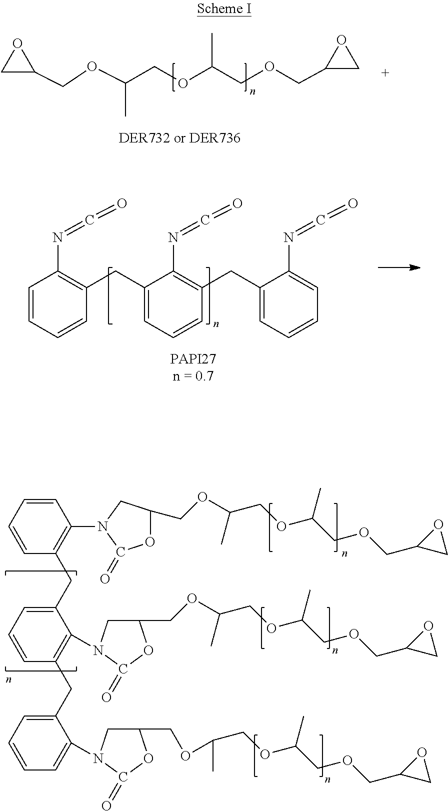

Example XQR-19 was prepared as follows:

A 1 L four neck glass reactor was cleaned with MEK, and dried. A N₂ purge was initiated to give a N₂ atmosphere. A reflex device and temperature controller were connected with the glass reactor.

An 870-gram quantity of D.E.R.™ 736 was added to the reactor and the temperature was increased to 125±5° C. with maximum stirring, 8.5 g (5% of total) PAPI27 was added until homogeneously mixed to neutralize trace of water.

The mixture was then heated up to 135° C. and DBU (1500 ppm) was added until the mixture was homogeneous.

The oil bath temperature was set to 170° C. When the reactant temperature reached 145-150° C., 25.5 grams of PAPI27 (15% of total) was added to initiate a strong exothermic reaction, the temperature increasing to more than 170° C.

An additional 136 grams of PAPI27 (80% of total) was added within 1-3.5 hours. The reaction temperature was kept between 170 to 180° C. After the addition of the PAPI27, the mixture continued to react at a temperature between 170 to 180° C. for an extra 0.5 hour. A sample was obtained for melt viscosity measurement and EEW titration.

The reaction was continued until the sample reached the theoretical EEW value and a sample was taken for measurement every 30 minutes.

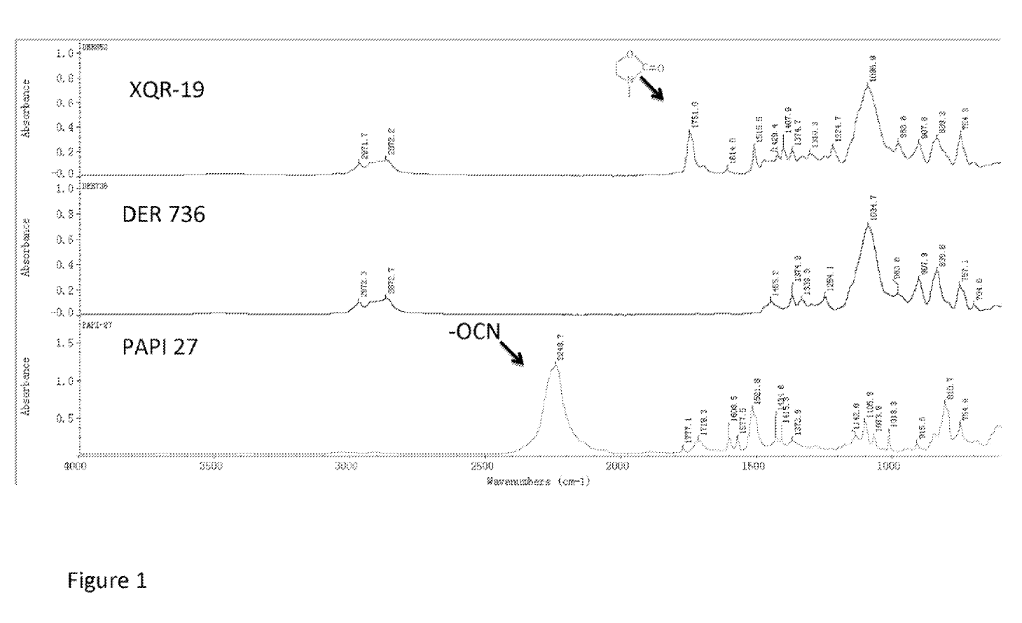

Referring to FIG. 1, as can be seen in FTIR spectra of DER852, the —OCN group (˜2248 cm⁻¹) had disappeared and yielded a number of oxazolidone rings (1751 cm⁻¹), indicating the reaction between the epoxy and NCO group to form an oxazolidone ring structure. Oxazolidone rings appear in this section of the IR spectra, as is evidenced in the examples of U.S. Pat. No. 5,112,932, herein incorporated by reference.

Another epoxy resin which was used in the present Examples is D.E.R.™ 383. The EEW of D.E.R.™ 383 was tested to be 181.

Three formulations (Example 1 and Comparative Examples A and B) are shown in Table I. D.E.R.™ 383 blending with Example XQR-19 was used as the epoxy part in Example 1 and D.E.R.™ 383 was used as epoxy part for Comparative Examples A and B. Fortegra-100, a block copolymer, was used as a toughener in Comparative Example B. MTHPA was used as a hardener and ethyltriphenylphosphonium acetate solution (70% solid content in methanol) was used as catalyst in the formulations. Standard testing panels of clear castings made by a molding device were tested for their mechanical properties. Samples of the formulations were cured at 100° C. for 2 hours, 120° C. for 2 hours and 160° C. for 2 hours in a mold, then mold was released for the thermal and mechanical properties tests.

The performances of the clear casting samples are also described in Table I. Tg was measured by DSC under N₂ atmosphere with 30° C. to 220° C., 10° C./minute for cycle 1; and 30° C. to 250° C., 10° C./minute for cycle 2.

TABLE I
Formulations and Properties of Epoxy/Anhydride System for Composites

| | | | | Comparative | Comparative | Comparative | Comparative |
|---|---|---|---|---|---|---|---|
| | EEW | HEW | Example 1 | Example A | Example B | Example C | Example D |
| DER 383 | 181 | | 47.57 | 53.22 | 48.31 | 49.47 | 51.28 |
| DER 736 | 190 | | | | 5.02 | | |
| Fortegra 100 | | | | | | 7.03 | 3.59 |
| Example | 313 | | 7.04 | | | | |
| XQR-19 | | | | | | | |
| MTHPA | | 166 | 44.99 | 46.37 | 46.26 | 43.10 | 44.72 |
| 70% ethyl | | | 0.4 | 0.4 | 0.4 | 0.4 | 0.41 |
| triphenol | | | | | | | |
| phosphonium | | | | | | | |
| acetate in | | | | | | | |
| 30% | | | | | | | |
| methanol | | | | | | | |

The above examples are all based on the weight percentage and amount of hardner are calculated by
equivalent ratio of EEW/HEW = 1:0.95
Process: 100 deg C., 2 hours + 160 deg C., 2 hours

| | | | | | |
|---|---|---|---|---|---|
| Tg (deg C.) | 130 | 138 | 129 | 133 | 134 |

Tensile Testing

| | | | | | |
|---|---|---|---|---|---|
| Elongation at yield (%) - | 5.4 | 4.9 | 53 | 4.7 | 4.9 |
| mean value | | | | | |
| Tensile strength at yield | 86 | 93 | 86 | 74 | 81 |
| (MPa) - mean value | | | | | |
| Automatic young's modules | 2901 | 3044 | 2889 | 2473 | 2712 |
| (MPa) - mean value | | | | | |
| Impact strength (Kj/m²) - | 10.7 | 8.7 | 8.5 | 14.4 | 13.8 |
| mean value | | | | | |
| Flexural testing | | | | | |
| Stress at yield (MPa) - mean | 134 | 139 | 127 | 116 | 118 |
| value | | | | | |
| Flexural strain at yield (%) - | 6.4 | 6.5 | 6.3 | 5.7 | 6.2 |
| mean value | | | | | |
| Automatic youngs modulus | 3229 | 3260 | 3114 | 2782 | 2999 |
| (MPa) - mean value | | | | | |

Rankings

| | | | | | |
|---|---|---|---|---|---|
| Tensile strength at yield | B | A | B | D | C |
| Elongation at yield | A | A | A | B | A |
| Tensile Automatic young's | B | A | B | D | C |
| modulus | | | | | |
| Impact strength | B | C | C | A | A |
| Flexural strength | B | A | C | D | D |
| Flexural strain | A | A | A | B | C |
| Flexural Automatic young's | A | A | B | D | C |
| modulus | | | | | |

The above results indicated that compared with the reference formulation which is comparative example A, the XQR-19 could improve the impact strength from 8.7% to 10.7% which is about a 23% increase with 7.04% addition, and it is significant a level increase from C to B. While properties like tensile strength, elongation, automatic young's modulus, flexural strain, flexural stress were nearly maintained at the same level. there was a drop of Tg about 8° C. from 138° C. to 130° C. Compared with comparative example B, the XQR-19 could give better impact strength properties from 8.5 to 10.7% which is about a 26% increase which is a significant level increase. While properties like tensile strength, elongation, automatic young's modulus, flexural strain, flexural stress and Tg were kept at the same level, Compared with comparative example C and comparative example D, XOR-19% exhibited higher tensile strength, flexural strength, elongation and modulus properties with significant improved level while the Tg and impact strength were slightly lower. It is intended that all matter herein disclosed be interpreted as illustrative only and not as limiting the scope of protection sought. Moreover, the process of the present invention is not to be limited by the specific examples set forth above including the tables to which they refer. Rather, these examples and the tables they refer to are illustrative of the process of the present invention.

1. A liquid adduct consisting essentially of a reaction product of
(a) an aliphatic epoxy resin, and
(b) an isocyanate compound; wherein the viscosity of the adduct comprises less than about 60 Pa-s at about 25° C.

2. The adduct of claim 1, wherein the epoxy resin comprises a polyglycol epoxy resin.

3. The adduct of claim 1, wherein the polyglycol epoxy resin comprises polypropylene glycol, polyethylene glycol, and mixtures thereof.

4. (canceled)

5. The adduct of claim 1 wherein the isocyanate compound is a polyfunctional isocyanate compound.

6. (canceled)

7. The adduct of claim 1 including (c) a catalyst.

8. The adduct of claim 1 wherein the weight ratio of (a) to (b) is between 60 to 98 for component (a) and 40 to 2 for component (b).

9. The adduct of claim 1 wherein the isocyanate compound is selected from the group consisting of MDI, TDI, hydrogenated MDI, hydrogenated TDI, and combinations thereof.

10. The adduct of claim 1 wherein the polyglycol epoxy resin is selected from the group consisting of poly propyleneglycol diglycidyl ether, dipropyleneglycol diglycidyl ether, 1,6-Hexanediol diglycidyl ether, 1,4-Butanediol diglycidyl ether and combinations thereof.

11. The adduct of claim 1, wherein the adduct comprises a compound of Formula I: 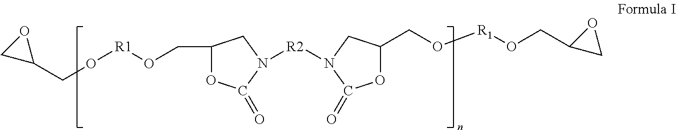
wherein R1 is selected from the group consisting of an aliphatic chain and a polyol chain, R2 is selected from the group consisting of a phenyl ring structure and a polymeric phenyl ring structure and n is an integer greater than 1.

12. The adduct of claim 7 wherein the catalyst is selected from the group consisting of 2-methyl imidazole, 2-phenyl imidazole, an imidazole derivative, 1,8-diazabicyclo[5.4.0]undec-7-ene (DBU), 2-methylimidazole-epoxy adduct, an isocyanate-amine adduct, and combinations thereof.

13. A composition comprising (a) the adduct of claim 1; (b) at least one epoxy resin; and (c) at least one hardener.

14. The composition according to claim 13, wherein the at least one epoxy resin comprises an aliphatic epoxy.

15. The composition according to claim 13, wherein the epoxy resin has an epoxide equivalent weight (EEW) of from about 100 to about 1000 and wherein the isocyanate compound has an isocyanate equivalent weight (IEW) of from about 100 to about 500.

16. (canceled)

17. The composition according to claim 13, wherein the amount of the adduct present in the composition comprises from about 0.1 weight percent to about 40 weight percent based on the weight of the total organic compounds.

18. The composition according to claim 13, wherein the at least one epoxy resin is selected from the group consisting of diglycidyl ether of bisphenol A, derivatives of diglycidyl ether of bisphenol A, diglycidyl ether of bisphenol F, derivatives of diglycidyl ether of bisphenol F, a multi-functional epoxy, and mixtures thereof.

19. The composition according to claim 13, wherein the molar ratio of the components (a) and (b) to hardener (c) is of from about 50:1 to about 1:2.

20. A process for preparing an adduct comprising reacting a reaction mixture consisting essentially of
(a) a polyglycol epoxy resin, and
(b) an isocyanate compound.

21. A process for preparing a composition comprising admixing
(a) an adduct of claim 1;
(b) at least one epoxy resin; and
(c) at least one hardener.

22. (canceled)

23. An article made by curing the composition of claim 13 wherein the article is selected from the group consisting of a composite, a coating film, or an encapsulation material.

24. The composite of claim 23 having a Tg of from about 50° C. to about 250° C.
